(19) United States
(12) Patent Application Publication
(10) Pub. No.: US 2024/0129731 A1
(43) Pub. Date: Apr. 18, 2024

(54) Registration in a Wireless Communication Network

(71) Applicant: Telefonaktiebolaget LM Ericsson )pub), Stockholm (SE)

(72) Inventors: Vlasios Tsiatsis, Stockholm (SE); Monica Wifvesson, Lund (SE)

(21) Appl. No.: 18/547,170

(22) PCT Filed: Feb. 22, 2022
(86) PCT No.: PCT/EP2022/054331

§ 371 Date: Aug. 21, 2023

Related U.S. Application Data
(60) Provisional application No. 63/152,190, filed on Feb. 22, 2021.

(51) Int. Cl. H04W 12/06; H04W 12/0431

(52) U.S. Cl. CPC H04W 12/06; H04W 12/0431

(57) ABSTRACT

A core network node (16) is configured for use in a wireless communication network (10). The core network node (16 receives a registration request (14) that requests registration of a wireless device (12) with the wireless communication network (10). The core network node (16) protects a security context (20) shared between the wireless device (12) and the core network node (16, e.g., including encrypting the security context (20). The core network node (16) transmits, to a radio network node (23) in the wireless communication network (10), signaling (24) that includes the registration request (14) and the protected security context (20P). In some embodiments, the signaling (24) indicates the registration request (14) and the protected security context (20P) are to be re-routed to a target core network node (18) in the wireless communication network (10).

### TECHNICAL FIELD

The present application relates generally to a wireless communication network, and relates more particularly to registration in such a network.

### BACKGROUND

In order for a wireless device to be served by a wireless communication network, the wireless device must register with that network. During the registration procedure, the wireless communication network, among other things, authenticates the wireless device, verifies that the wireless device is authorized to receive wireless communication services from the network, establishes a security context with the wireless device to protect communication with the wireless device, and the like.

However, the initial core network node to receive a registration request from a wireless device, such as an initial Access and Mobility Function (AMF) in a 5G network, may not be able to serve the wireless device or may not be the most suitable to do so. For example, where the wireless communication network has multiple network slices, so as to multiplex virtualized and independent logical networks on the same physical network infrastructure, the initial core network node may serve a different network slice than the network slice with which the wireless device is requesting registration. Or, where the wireless communication network deploys multiple instances of the core network node into a set, set deployment constraints may dictate that the wireless device cannot be served by the initial core network node instance or set that receives the registration request. No matter the reason, the initial core network node under some circumstances must re-route the registration request to another, target core network node. In doing so, the initial core network node must also transfer the security context for the wireless device to the target core network node.

In some cases, though, isolation requirements on the core network nodes or deployment restrictions mean that no direct communication interface (e.g., N14 interface) exists between the initial core network node and the target core network node. Challenges exist therefore in how to re-route the registration request and transfer the wireless device's security context in these cases where there is no direct communication interface over which to do so.

### SUMMARY

According to some embodiments herein, a core network node (e.g., AMF) that initially receives a wireless device's registration request exploits the radio access network (RAN) for re-routing the request and transferring the wireless device's security context to a target core network node, e.g., to which no direct communication interface exists. Notably, before re-routing the registration request and transferring the security context via the RAN, the initial core network node encrypts the security context, e.g., using cryptographic keying material specific to and/or shared with the target core network node. Encrypting the security context in this way advantageously protects the security context against attack at the RAN level so as to enable secure transfer of the security context despite the lack of a direct (and thereby protected) interface with the target core network node.

More particularly, embodiments herein include a method performed by a core network node in a wireless communication network. The method comprises receiving a registration request that requests registration of a wireless device with the wireless communication network. The method also comprises protecting a security context shared between the wireless device and the core network node. In some embodiments, protecting the security context comprises encrypting the security context. The method also comprises transmitting, to a radio network node in the wireless communication network, signaling that includes the registration request and the protected security context. In some embodiments, the signaling indicates the registration request and the protected security context are to be re-routed to a target core network node in the wireless communication network.

In some embodiments, protecting the security context comprises protecting the security context with cryptographic material that is specific to the target core network node or to a target core network node set to which the target core network node belongs. Additionally or alternatively, protecting the security context comprises protecting the security context with cryptographic material that is shared between the core network node and the target core network node or is shared between the core network node and a target core network node set to which the target core network node belongs.

In some embodiments, the method further comprises obtaining, from a common network node that is accessible to both the core network node and the target core network node, cryptographic material with which to protect the security context. In some embodiments, the common network node implements a network slice selection function, NSSF, and serves multiple network slices of the wireless communication network.

In some embodiments, obtaining the cryptographic material comprises transmitting, to the common network node, a request for the cryptographic material and for a cryptographic material reference associated with the cryptographic material, and then receiving the cryptographic material and the cryptographic material reference in response to the request. In some embodiments, the signaling transmitted to the radio network node further includes the cryptographic material reference. The cryptographic material reference may for example comprise an identifier of the cryptographic material or comprises a token specific to the cryptographic material.

In some embodiments, the request for the cryptographic material and for the cryptographic material reference includes an identifier or address of the target core network node, or an identifier or address of a target core network node set to which the target core network node belongs. Additionally or alternatively, the request includes an identifier or address of the core network node, or an identifier or address of a core network node set to which the core network node belongs. Additionally or alternatively, the request includes an identifier that identifies the wireless device or identifies a subscription associated with the wireless device. Additionally or alternatively, the request includes the registration request.

In some embodiments, the signaling further includes one or more parameters. In some embodiments, at least one of the one or more parameters is associated with the registration request. In other embodiments, at least one of the one or more parameters additionally or alternatively is associated with a procedure for the radio network node to route the registration request to the target core network node. Additionally or alternatively, at least one of the one or more parameters is associated with cryptographic material usable by the target core network node to decrypt and/or verify an integrity of the protected security context. In some embodiments, the method further comprises packaging the security context and the one or more parameters into a container. In some embodiments, protecting the security context comprises protecting the container. In some embodiments, the signaling includes the protected container. In one or more of these embodiments, the one or more parameters include an uplink or downlink non-access stratum count value. In other embodiments, the one or more parameters alternatively or additionally include a horizontal key derivation indicator that indicates whether or not the core network node has performed horizontal key derivation to derive a cryptographic key included in the security context. Additionally or alternatively, the one or more parameters may include a timestamp usable to verify a validity of cryptographic material usable by the target core network node to decrypt and/or verify an integrity of the protected security context. Additionally or alternatively, the one or more parameters may include an address of the target core network node.

In some embodiments, the core network node implements an access and mobility function, AMF. In some embodiments, the target core network node implements a target AMF.

Other embodiments herein include a method performed by a core network node in a wireless communication network. The method comprises receiving, from a radio network node in the wireless communication network, signaling that includes a registration request and a protected security context. In some embodiments, the registration request requests registration of a wireless device with the wireless communication network. In some embodiments, the protected security context comprises a security context protected with encryption. In some embodiments, the security context is shared between the wireless device and another core network node. The method also comprises performing one or more security actions on the protected security context. In some embodiments, the one or more security actions include decrypting the protected security context in order to obtain the security context. The method also comprises handling the registration request using the security context.

In some embodiments, performing one or more security actions on the protected security context comprises performing one or more security actions on the protected security context with cryptographic material that is specific to the core network node or to a core network node set to which the core network node belongs. Additionally or alternatively, performing one or more security actions on the protected security context comprises performing one or more security actions on the protected security context with cryptographic material that is shared between the core network node and another core network node from which the registration request was re-routed or is shared between a core network node set to which the core network node belongs and another core network node from which the registration request was re-routed.

In some embodiments, the method further comprises obtaining, from a common network node that is accessible to both the core network node and a core network node from which the registration request was re-routed, cryptographic material with which to perform the one or more security actions on the protected security context. In one or more of these embodiments, the common network node implements a network slice selection function, NSSF, and serves multiple network slices of the wireless communication network.

In one or more of these embodiments, obtaining the cryptographic material comprises transmitting, to the common network node, a request for the cryptographic material and receiving the cryptographic material in response to the request. In some embodiments, the request includes a cryptographic material reference associated with the cryptographic material, e.g., where the cryptographic material reference may comprise an identifier of the cryptographic material or comprises a token specific to the cryptographic material. In some embodiments, the cryptographic material reference is included in the signaling received from the radio network node. Additionally or alternatively, the request includes an identifier or address of the core network node, or an identifier or address of a core network node set to which the core network node belongs. Additionally or alternatively, the request includes the registration request.

In some embodiments, the signaling further includes one or more parameters. In some embodiments, at least one of the one or more parameters is associated with the registration request or is associated with cryptographic material usable by the target core network node to decrypt and/or verify an integrity of the protected security context. In some embodiments, receiving the signaling including the protected security context comprises receiving a protected container that includes the security context and the one or more parameters. In some embodiments, performing one or more security actions on the protected security context comprises performing the one or more security actions on the protected container. In one or more of these embodiments, the one or more parameters include an uplink or downlink non-access stratum count value. Additionally or alternatively, in other embodiments, the one or more parameters include a horizontal key derivation indicator that indicates whether or not the another core network node has performed horizontal key derivation to derive a cryptographic key included in the security context. Additionally or alternatively, in other embodiments, the one or more parameters include a timestamp usable to verify a validity of cryptographic material usable by the core network node to decrypt and/or verify an integrity of the protected security context.

In some embodiments, the core network node implements an access and mobility function, AMF.

Other embodiments herein include a method performed by a network node in a wireless communication network. The method comprises receiving, from a core network node in the wireless communication network, a request for cryptographic material.

In some embodiments, the request includes one or more parameters. In some embodiments, the one or more parameters comprise an identifier or address of the core network node and/or an identifier or address of a core network node set to which the core network node belongs. Additionally or alternatively, the one or more parameters comprise an identifier or address of another core network node with which the cryptographic material is to be shared, and/or an identifier or address of another core network node set to which said another core network node belongs. Alternatively or additionally, the one or more parameters comprise an identifier that identifies a wireless device or identifies a subscription associated with the wireless device. Additionally or alternatively, the one or more parameters comprise a registration request requesting registration of the wireless device with the wireless communication network. In these and other embodiments, the method may also comprise generating the requested cryptographic material based on at least one of the one or more parameters included in the request.

More specifically, in some embodiments, the request includes three or more parameters. In some embodiments, the three or more parameters comprise at least: (i) an identifier or address of the core network node or an identifier or address of a core network node set to which the core network node belongs; (ii) an identifier or address of another core network node with which the cryptographic material is to be shared, or an identifier or address of another core network node set to which said another core network node belongs; and (iii) a registration request requesting registration of the wireless device with the wireless communication network. In these and other embodiments, the method may also comprise generating the requested cryptographic material based on the three or more parameters included in the request.

In any event, the method as shown also comprises transmitting, to the core network node, the generated cryptographic material in response to the request.

In some embodiments, the cryptographic material is specific to the core network node or to a core network node set to which the core network node belongs.

In some embodiments, the method further comprises transmitting, to the core network node, a cryptographic material reference associated with the cryptographic material in response to the request. In some embodiments, the cryptographic material reference comprises an identifier of the cryptographic material or comprises a token specific to the cryptographic material.

In some embodiments, the network node implements a network slice selection function, NSSF, and serves multiple network slices of the wireless communication network.

In some embodiments, the core network node implements an access and mobility function, AMF.

Other embodiments herein include a core network node configured for use in a wireless communication network. The core network node comprises communication circuitry and processing circuitry. The processing circuitry is configured to receive a registration request that requests registration of a wireless device with the wireless communication network. The processing circuitry is also configured to protect a security context shared between the wireless device and the core network node. In some embodiments, protecting the security context comprises encrypting the security context. The processing circuitry is also configured to transmit, to a radio network node in the wireless communication network, signaling that includes the registration request and the protected security context. In some embodiments, the signaling indicates the registration request and the protected security context are to be re-routed to a target core network node in the wireless communication network.

In some embodiments, the processing circuitry is configured to perform the steps described above for a core network node in a wireless communication network.

Other embodiments herein include a core network node configured for use in a wireless communication network. The core network node comprises communication circuitry and processing circuitry. The processing circuitry is configured to receive, from a radio network node in the wireless communication network, signaling that includes a registration request and a protected security context. In some embodiments, the registration request requests registration of a wireless device with the wireless communication network. In some embodiments, the protected security context comprises a security context protected with encryption. In some embodiments, the security context is shared between the wireless device and another core network node. The processing circuitry is also configured to perform one or more security actions on the protected security context. In some embodiments, the one or more security actions include decrypting the protected security context in order to obtain the security context. The processing circuitry is also configured to handle the registration request using the security context.

In some embodiments, the processing circuitry is configured to perform the steps described above for a core network node in a wireless communication network.

Other embodiments herein include a network node configured for use in a wireless communication network. The network node comprises communication circuitry and processing circuitry. The processing circuitry is configured to receive, from a core network node in the wireless communication network, a request for cryptographic material. In some embodiments, the request includes one or more parameters. In some embodiments, the one or more parameters comprise an identifier or address of the core network node. Additionally or alternatively, the one or more parameters comprise an identifier or address of a core network node set to which the core network node belongs. Additionally or alternatively, the one or more parameters comprise an identifier that identifies a wireless device or identifies a subscription associated with the wireless device. Additionally or alternatively, the one or more parameters comprise a registration request requesting registration of the wireless device with the wireless communication network. The processing circuitry is also configured to generate the requested cryptographic material based on at least one of the one or more parameters included in the request. The processing circuitry is also configured to transmit, to the core network node, the generated cryptographic material in response to the request.

In some embodiments, the processing circuitry is configured to perform the steps described above for a network node in a wireless communication network.

Other embodiments herein include a computer program comprising instructions which, when executed by at least one processor of a core network node, causes the core network node to perform the steps described above for a core network node in a wireless communication network. Other embodiments herein include a computer program comprising instructions which, when executed by at least one processor of a network node, causes the network node to perform the steps described above for a network node in a wireless communication network. In one or more of these embodiments, a carrier containing the computer program is one of an electronic signal, optical signal, radio signal, or computer readable storage medium.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network according to some embodiments.

FIG. 2 is a call flow diagram of a registration procedure for a wireless device according to some embodiments.

FIG. 3 is a call flow diagram of a registration procedure for a wireless device according to some embodiments that utilize asymmetric cryptography.

FIG. 4 is a call flow diagram of a registration procedure for a wireless device according to some embodiments that utilize symmetric cryptography.

FIG. 5 is a call flow diagram of a registration procedure for a wireless device according to other embodiments that utilize symmetric cryptography.

FIG. 6 is a logic flow diagram of a method performed by a wireless device according to some embodiments.

FIG. 7 is a logic flow diagram of a method performed by a core network node according to some embodiments.

FIG. 8 is a logic flow diagram of a method performed by a network node according to some embodiments.

FIG. 9 is a block diagram of a core network node according to some embodiments.

FIG. 10 is a block diagram of a network node according to some embodiments.

FIG. 11 is a block diagram of a communication system in accordance with some embodiments

FIG. 12 is a block diagram of a user equipment according to some embodiments.

FIG. 13 is a block diagram of a network node according to some embodiments.

### DETAILED DESCRIPTION

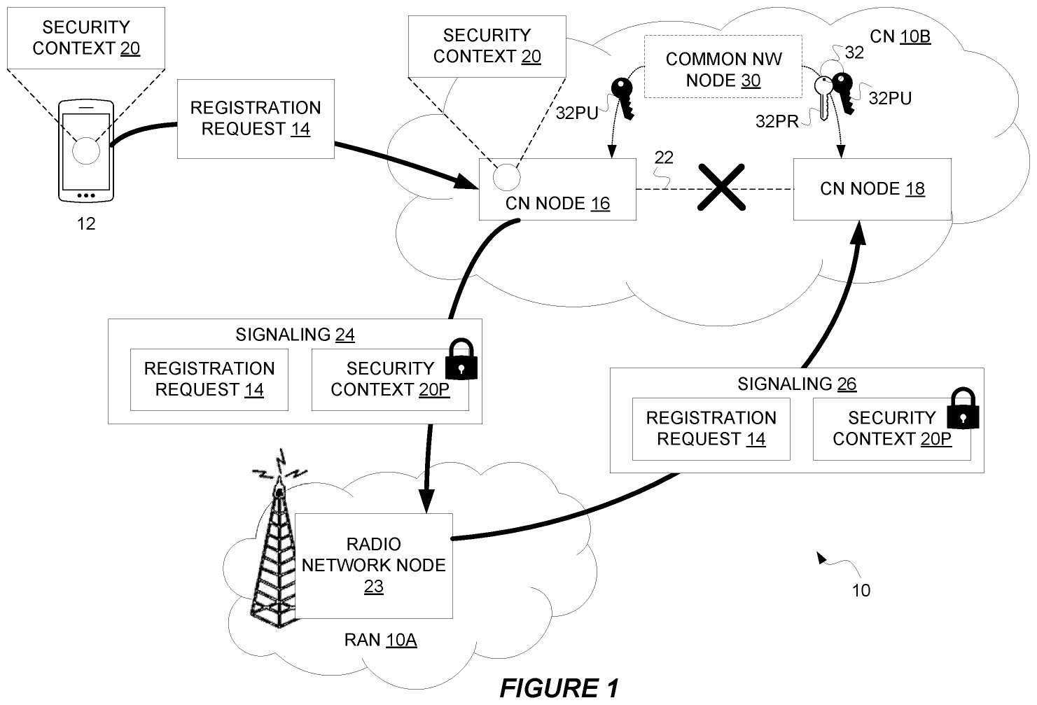

FIG. 1 shows a wireless communication network 10 that provides wireless communication service to wireless devices according to some embodiments. The wireless communication network 10 includes a radio access network (RAN) 10A that provides radio access to wireless devices, one of which is shown as wireless device 12. The RAN 10A in turn connects the wireless device 12 with a core network (CN) 10B of the wireless communication network 10, e.g., where the CN 10B in some embodiments is independent of the type of radio access used by the RAN 10A.

In order to receive service from the wireless communication network 10, wireless device 12 transmits a registration request 14 to a core network (CN) node 16 in the CN 10B. The CN node 16 may for instance implement an Access and Mobility Function (AMF) in embodiments where the wireless communication network 10 is a 5G network. Regardless, the registration request 14 requests registration of the wireless device 12 with the wireless communication network 10. The registration request 14 in some embodiments is a non-access stratum (NAS) message that the wireless device 12 transmits to the CN node 16 over a NAS. Although not shown, the wireless device 12 transmits the registration request 14 to the CN node 16 via the RAN 10A.

In some embodiments, though, this CN node 16 that initially receives the registration request 14 is unable to serve the wireless device 12 or is not the most suitable to do so. For example, where the wireless communication network 10 has multiple network slices, so as to multiplex virtualized and independent logical networks on the same physical network infrastructure, this initial CN node 16 may serve a different network slice than the network slice with which the wireless device 12 is requesting registration. This may happen, for instance, if the RAN 10A does not know which CN nodes serve which network slices and as a result ends up forwarding the registration request 14 to CN node 16 even though CN node 16 does not serve the intended network slice. Or, where CN 16 represents just one of multiple instances of the type of the core network node in a set, set deployment constraints may dictate that the wireless device 12 cannot be served by the CN 16 or the set to which the CN node 16 belongs. No matter the reason, the initial CN node 16 decides to re-route the registration request 14 to another, target CN node 18, e.g., a target AMF. In doing so, the initial CN node 16 must also transfer a security context 20 for the wireless device 12 to the target CN node 18. This security context 20 is the security context that is shared between the wireless device 12 and the initial CN node 16, e.g., the security context 20 may be a non-access stratum (NAS) security context and/or may include cryptographic material usable for protecting communication between the wireless device 12 and the initial CN node 16.

However, as shown, no direct communication interface 22 exists between the initial CN node 16 and the target CN node 18. The lack of interface 22 may for instance be because isolation requirements on the CN nodes 16, 18 or deployment restrictions.

The initial CN node 16 nonetheless exploits the RAN 10A for re-routing the registration request 14 and transferring the security context 20 to the target RAN node 18, since the RAN 10A is commonly connected to both the initial CN node 16 and the target RAN node 18. In particular, the initial CN node 16 re-routes the registration request 14 and transfers the security context 20 to the target RAN node 18 via a radio network node 23 in the RAN 10A, e.g., a base station or relay node.

Notably, before re-routing the registration request 14 and transferring the security context 20 via the radio network node 23, the initial CN node 16 protects the security context 20, e.g., using cryptographic material specific to and/or shared with the target CN node 18. The cryptographic material may for instance include one or more keys, and may also include one or more other parameters such as cryptographic algorithm initial vector, salts, or the like. In some embodiments, protecting the security context 20 includes encrypting the security context 20 and/or integrity protecting the security context 20, e.g., using the same or different cryptographic material. Encrypting and/or integrity protecting the security context 20 in this way advantageously protects the security context 20 against attack at the RAN level so as to enable secure transfer of the security context 20 despite the lack of a direct (and thereby protected) interface 22 with the target CN node 18.

More particularly, as shown in FIG. 1, the initial CN node 16 protects the security context 20 to obtain the protected security context 20P. The initial CN node 16 then transmits, to the radio network node 23, signaling 24 that includes the registration request 14 and the protected security context 20P. The signaling 24 in some embodiments also indicates that the registration request 14 and the protected security context 20P are to be re-routed to the target CN node 18. In accordance with this signaling 24, the radio network node 23 in turn transmits, to the target CN node 18, signaling 26 that includes the registration request 14 and the protected security context 20P. The signaling 26 in this regard may be the same or different than signaling 24, e.g., the radio network node 23 may simply forward the received signaling 24 as signaling 26 or may re-package the received signaling 24 as signaling 26. Regardless, the target CN node 18 correspondingly performs one or more security actions on the protected security context 20P included in the signaling 26, in order to recover the security context 20. The one or more security actions may for example include decrypting the protected security context 20P and/or verifying an integrity of the protected security context 20P. The target CN node 18 can then handle the registration request 14 using the recovered security context 20.

Although not shown, the signaling 24 and/or the signaling 26 may include one or more other parameters besides the protected security context 20P. At least one of the one or more other parameters may for instance be associated with the registration request 14. For example, the other parameter(s) may include an uplink (UL) or downlink (DL) NAS count value and/or include a horizontal key derivation indicator that indicates whether or not the CN node 16 has performed horizontal key derivation to derive a cryptographic key included in the security context 20. Alternatively or additionally, at least one of the one or more other parameters may be associated with a procedure for the radio network node 23 to route the registration request 14 to the target CN node 18. For example, the other parameter(s) may include an address of the target CN node 18. Alternatively or additionally, at least one of the other parameter(s) may be associated with cryptographic material usable by the target CN node 18 to decrypt and/or verify an integrity of the protected security context 20P. For example, the other parameter(s) may include a timestamp usable to verify a validity of cryptographic material usable by the target CN node 18 to decrypt and/or verify an integrity of the protected security context 20P, or include an identifier that identifies an algorithm with which the security context 20 is encrypted and/or integrity protected.

In these and other embodiments where the signaling 24, 26 includes one or more other parameters, the signaling 24, 26 may package the protected security context 20P and/or the other parameter(s) in a container, e.g., a message or information element (IE). In some embodiments, for example, the initial CN node 16 packages the security context 20 and the one or more parameters into a container, and protects the security context 20 and/or the other parameter(s) by protecting at least a part of the container. The initial CN node 16 in this regard may encrypt and/or integrity protect the container as a whole, or may encrypt and/or integrity protect one or more parts of the container. The signaling 24, 26 in either case includes the (at least partially) protected container. Generally, then, the initial CN node 16 may protect the security context 20 directly or indirectly, where indirectly protecting the security context 20 may involve protecting at least a part of the container within which the security context 20 is included. The same may be said for the other parameter(s).

Regardless, in some embodiments, the initial CN node 16 protects the security context 20 with cryptographic material, such as cryptographic keying material. The target CN node 18 may correspondingly perform the security action(s), such as decryption and/or integrity verification, based on the same or different cryptographic material. In some embodiments, for example, the cryptographic material may be specific to the target CN node 18 or to a target core network node set to which the target CN node 18 belongs. Alternatively or additionally, the cryptographic material may be shared between the initial CN node 16 and the target CN node 18 or be shared between the initial CN node 16 and a target core network node set to which the target CN node 18 belongs.

These and other embodiments may facilitate sharing of cryptographic material between the initial CN node 16 and the target CN node 18, despite the lack of direct interface between those CN nodes 16, 18, by exploiting a common network (NW) node 30 that is accessible (i.e., common) to both the initial CN node 16 and the target CN node 18. In some embodiments where the initial CN node 16 and the target CN node 18 serve different network slices of the wireless communication network 10, the common NW node 30 may serve multiple network slices, e.g., including both the network slice served by the initial CN node 16 and the network slice served by the target CN node 18. The common NW node 30 may for example implement a network slice selection function, a unified data management (UDM), a service communication proxy (SCP), or an authentication server function (AUSF), e.g., in a 5 g network. Regardless, in some embodiments, the common NW node 30 generates or otherwise obtains the cryptographic material and shares that cryptographic material (or corresponding subsets or versions of the cryptographic material) with the CN nodes 16, 18. In other embodiments, the initial CN node 16 generates the cryptographic material, shares the cryptographic material with the common NW node 30, and the common NW node 30 in turn shares the cryptographic material with the target CN node 18.

Consider for instance one embodiment that utilizes asymmetric cryptography. In this case, as shown in FIG. 1, the common NW node 30 may generate or obtain a set 32 of keys specific to the target CN node 18, where the set of keys includes a private key 32PR and a public key 32PU. The common NW node 30 may provision the initial CN node 16 with the public key 32PU and provision the target CN node 18 with the private key 32PR (and potentially also the public key 32PU). The initial CN node 16 in this case may protect (e.g., encrypt and/or integrity protect) the security context 20 using the public key 32PU and the target CN node 18 may perform security action(s) (e.g., decrypt and/or perform integrity verification) using the private key 32PR. In some embodiments, the common NW node 30 may provision the CN nodes 16, 18 with the keys in this way proactively, in advance, so that the keys will be available if and when needed. In other embodiments, by contrast, the common NW node 30 provisions the CN nodes 16, 18 with the keys reactively, on an as-needed basis.

Other embodiments herein may utilize symmetric cryptography. In one embodiment, for example, the initial CN node 16 transmits, to the common NW node 30, a request for cryptographic material usable to protect the security context 20 and for a cryptographic material reference associated with the cryptographic material, e.g., where the cryptographic material reference may for instance be an identifier that identifies the cryptographic material or a token specific to the cryptographic material. The request may include an identifier or address of the target CN node 18, an identifier or address of a target core network node set to which the target CN node 18 belongs, an identifier that identifies the wireless device 12 or identifies a subscription associated with the wireless device 12, and/or the registration request 14. In response to the request, the common NW node 30 may generate, and transmit to the initial CN node 16, the cryptographic material and the cryptographic material reference. The initial CN node 16 may use that cryptographic material to protect the security context 20 and in turn include the cryptographic material reference in the signaling 24 to the radio network node 23. The radio network node 23 relays this reference on to the target NW node 18. This way, the target CN node 18 can provide the cryptographic material reference to the common NW node 30 in a request for cryptographic material, so as to recover the same (or corresponding) cryptographic material that the initial CN node 16 used to protect the registration request 14. The target CN node 18 then performs security action(s) using that cryptographic material.

Consider now a few examples in a context where the initial CN node 16 implements an initial AMF, the target CN node 16 implements a target AMF, and the wireless device 12 is a user equipment (UE). In this case, the initial AMF protects (e.g., encrypts) the security context 20 and forwards/transfers the protected security context 20P along with the registration request 14 to the target AMF via the RAN 10A. Protected in this way, the RAN 10A does not have access to the security context 20. Moreover, any parameters needed for retrieving cryptographic material (e.g., protection keys) for the security context 20 may be within a common NW node (e.g., CN entity) and are not accessible to the RAN 10A, e.g., as the RAN 10A cannot use a service-based architecture (SBA) interface to access any core network function.

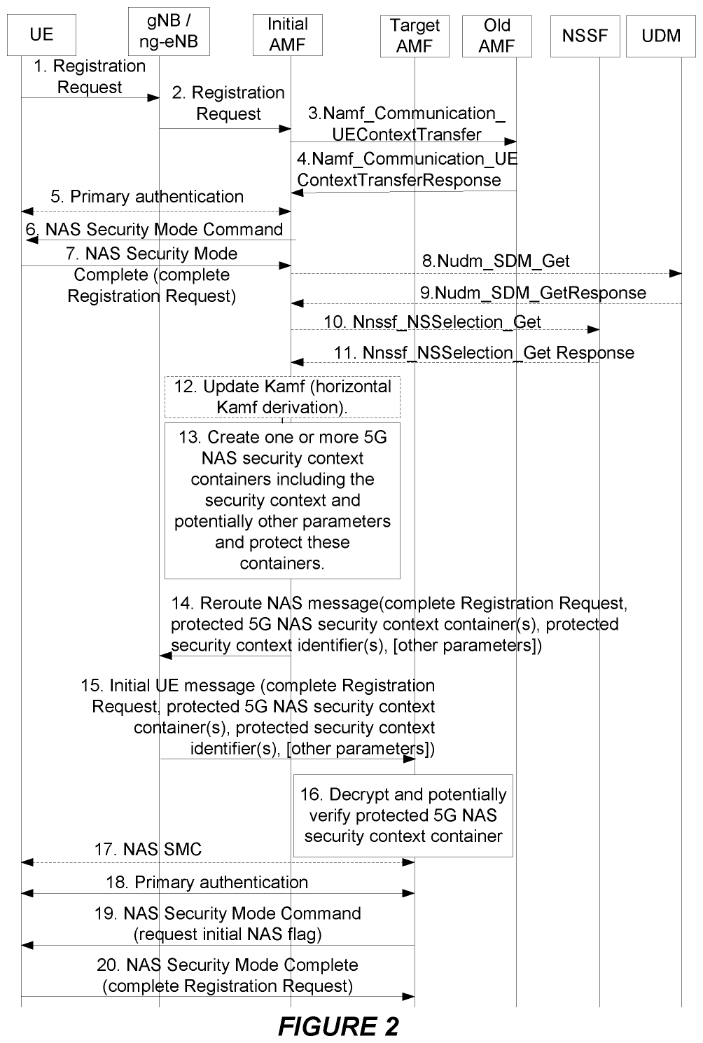

FIG. 2 shows one such embodiment in the context of a registration procedure for a 5G network, e.g., consistent with 3GPP TS 23.502 V16.7.0.

The AMF re-allocation procedure shown results in the UE and Initial AMF sharing a security context. Therefore, encryption and integrity protection keys that could be used for the secure communication between the UE and the Initial AMF are included in this security context. The NAS Security Mode Command in Steps 6 and 7 takes the security context into use between the UE and the Initial AMF. After the NAS SMC procedure, the Initial AMF receives the initial registration request, which may have slicing information such as Network Slice Selection Assistance Information (NSSAI). Based upon this slicing information, the Initial AMF may determine that it is not the right AMF to serve the UE and so performs a look up for an appropriate AMF (steps 8-11).

As soon as the initial AMF determines that an AMF re-allocation is to be performed and as soon as it identifies the target AMF (or a set of AMFs to which the target AMF belongs), the initial AMF protects the security context, e.g., by encrypting and potentially integrity protecting the security context 20. The initial AMF in some embodiments may protect one or more other parameters, e.g., Uplink/Downlink(UL/DL) NAS COUNT values and/or the horizontal key derivation indicator (keyAmfHDerivationInd). In one embodiment as shown in FIG. 2, for example, the initial AMF protects the security context 20 and/or the other parameter(s) into a protected 5G NAS security context container (Step 13) and includes this container along with the normal Registration Request re-routing via the RAN (Steps 14, 15). The Initial AMF may decide to perform a horizontal key derivation of the AMF key (Kamf-0) to produce Kamf-1 (Step 12) included in the security context before protecting and dispatching the protected security context to the Target AMF. The Target AMF decrypts and potentially verifies the integrity of the protected 5G NAS security context container and extracts the security context and potentially other parameters (Step 16). The Target AMF uses the decrypted security context and potentially the other parameters for further interaction with the UE. For example, if in Step 12 the Initial AMF performed horizontal key derivation, then in Step 17 the Target AMF performs a NAS Security Mode Command (SMC) to bring the horizontally derived context into use. Then the Target AMF performs a primary authentication and NAS SMC (Step 18) in order to create a new security context of its own and bring it into use (Steps 19, 20). In the NAS SMC procedure, the Target AMF indicates that it requests the initial Registration Request (RR) message (Step 19) and the Target AMF may decide to compare the RR message received from the UE in Step 20 and the RR received by the Initial AMF in Step 15 and perform some action e.g. alert an Operations and Management (O&M) system that the Initial AMF has potentially altered the RR before sending it to the Target AMF.

More particularly, in Step 13 of FIG. 2, the Initial AMF creates a 5G NAS security context container including information similar to the SeafData (TS 29.518, v17.0.0, clause 6.1.6.2.35) and potentially other parameters such as UL/DL NAS COUNTs. If the Initial AMF performed horizontal key derivation, then the keyAmfHDerivationInd will be set to true and the key transported in the container will be Kamf-1 (horizontally derived from Kamf-0).

In Steps 14-15, the Initial AMF re-routes the RR via the RAN but apart from the RR it also includes the protected 5G security context container. The Initial AMF also includes some information (security context container identifier) that the Target AMF can potentially use for the decryption and integrity verification of the encrypted 5G NAS security context container. The Initial AMF may also include other parameters (e.g. Uplink/Downlink NAS COUNTs, target AMF address(es), timestamp) in the message to RAN. The RAN may forward some or all of these other parameters (e.g. Uplink/Downlink NAS COUNTs, Initial AMF address, timestamp) to the Target AMF while using some other others (e.g. target AMF address(es)) for the purposes of forwarding.

In Step 16, the Target AMF decrypts and potentially verifies the encrypted 5G NAS security context container and uses the decrypted information in the following steps.

In Step 17, if in Step 12 the Initial AMF has performed horizontal key derivation (indicated by the keyAmfHDerivationInd indicator in the decrypted 5G NAS security context container) the Target AMF initiates a NAS SMC to take the horizontally derived security context into use.

Some embodiments herein advantageously prevent the UE from dropping an unprotected AUTHRQ message from the Target AMF. Indeed, if the Target AMF cannot be contacted by the Initial AMF in order to transfer the security context shared between the UE and the Initial AMF, the Target AMF would heretofore try to authenticate the UE again by issuing an unprotected NAS message (AUTHENTICATION REQUEST, or AUTHRQ for short). According to the rules in TS 24.501 v17.1.0 (clause “4.4.4.2 Integrity checking of NAS signalling messages in the UE”) this unprotected AUTHRQ message will be dropped by the UE since it already has a security context with the network (with the Initial AMF though, not the Target AMF).

Note that, in the example, the Initial AMF and Target AMF use some shared knowledge in order to encrypt and potentially integrity protect and decrypt/verify the integrity of a 5G NAS security context container. There are various ways to achieve this shared knowledge, depending on what information about the Target AMF the Initial AMF has before Step 12 in FIG. 2.

If the Initial AMF has one specific Target AMF address, then the Initial AMF uses shared information between itself and the specific Target AMF to encrypt one copy of the 5G NAS security context container.

By contrast, if the Initial AMF has a set of specific Target AMF addresses (e.g., because the Initial AMF does not know a specific Target AMF address), then the Initial AMF uses shared information between itself and these multiple target AMFs to encrypt multiple copies of the 5G NAS security context container, one for each target AMF. Then in Steps 14, 15 there are multiple encrypted NAS security context containers that are encrypted, each identified by a Target AMF address. Upon the reroute of the RR message via RAN in Step 15, the RAN node selects a specific Target AMF. In Step 16, the specific Target AMF selected by the RAN node in Step 15, uses only the encrypted 5G NAS security context container that corresponds to its own address.

In yet another embodiment, the initial AMF has Target AMF set information, e.g., where the information is on a set level rather than an individual AMF level. The information may for instance be an address and/or descriptor of a target AMF set. In this case, the Target AMF set includes target AMFs that share some specific information (e.g. shared keys) that the Initial AMF obtains in some way. Regardless, the Initial AMF uses shared information between itself and the Target AMF set to encrypt one copy of the 5G NAS security context container. Upon the reroute of the RR message via RAN in Step 15, the RAN node may select a specific Target AMF within the AMF set (e.g., based on load balancing criteria).

Regardless, in some embodiments, the cryptographic material to protect the security context 20 may be associated with the Initial AMF, the target AMF(s), the UE and the RR. In this case, the cryptographic material may be generated using and/or be mapped to the identifier for the wireless device or subscription, the Initial AMF address, the RR, and/or the target AMF address(es) or the target AMF set identifier.

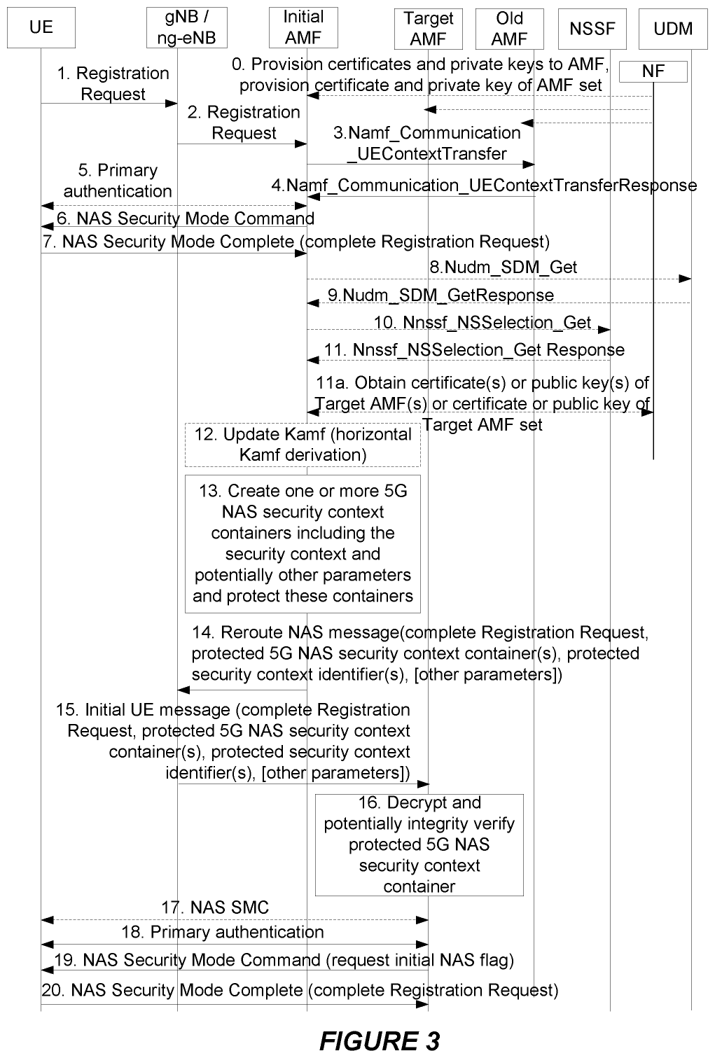

Consider now various detailed examples on how to share cryptographic material between the Initial AMF and the Target AMF in this example. FIG. 3 shows one alternative that utilizes asymmetric cryptography, whereby the Initial AMF protects (encrypts and potentially signs) the 5G NAS security context container(s) using the certificates or public keys of the relevant AMF(s). The assumption in this case is that the Initial AMF holds the public key of the Target AMF(s) or the public key of the Target AMF set that will be the recipient of the RAN reroute message (Step 14, 15) in FIG. 2. If the Initial AMF does not have such keys, then the Initial AMF obtains these keys from a NF that holds such keys, where the NF here is an example of common NW node 30. Such a NF serves all the existing slices in some embodiments. FIG. 3 shows this NF being different from the other NFs in the figure but this NF could be the Network Slice Selection Function (NSSF), Authentication Server Function (AUSF), Unified Data Management (UDM), Service Communication Proxy (SCP), or any other NF that can serve all slices. The Target AMF is also assumed that it holds its own private key or the private key of the Target AMF set after a provisioning step 0 by the NF or an Operations and Management (O&M) function. Step 0 is assumed to provision all the AMFs in the network with a private key. Then in Step 16 the Target AMF uses its own private key or the private key of the target AMF set to decrypt and potentially verify the integrity of the protected 5G NAS security context container.

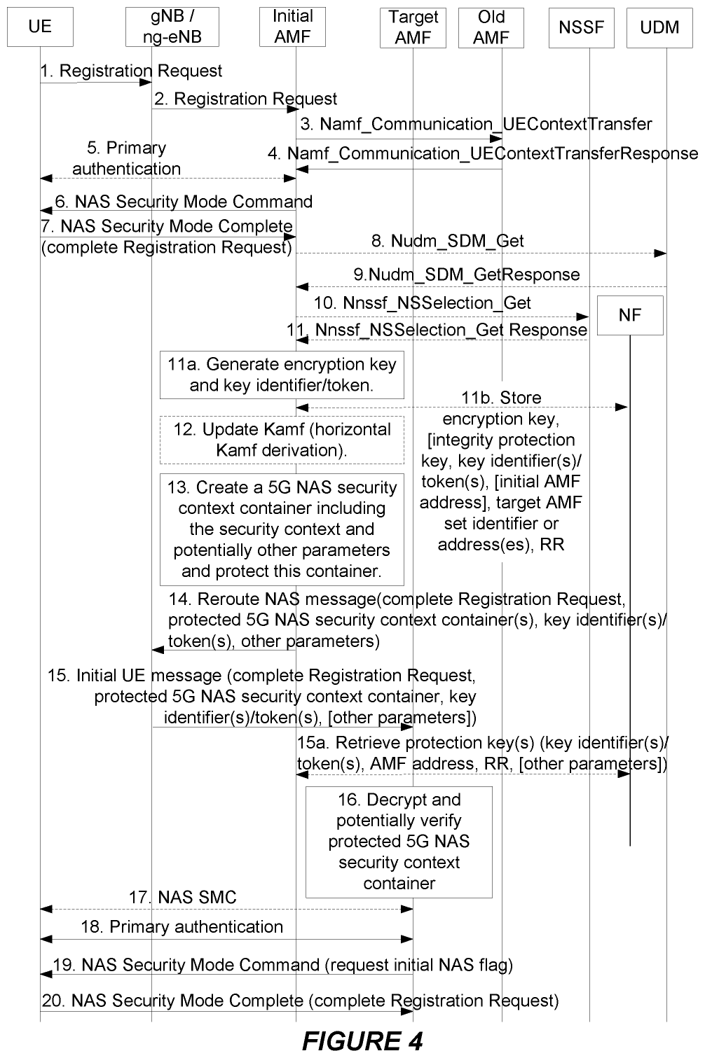

FIG. 4 shows another alternative that utilizes symmetric cryptography, where the Initial AMF generates the key(s) used to protect the security context. In this alternative, the Initial AMF generates the encryption and/or integrity verification keys and uses a network function to store and make the key available to the Target AMF. More particularly, the Initial AMF generates an encryption key for the 5G security context container and its key identifier/token in Step 11a. The key can be unique per UE or unique per Registration Request.

In Step 11b, the Initial AMF stores this key and a key identifier to a NF that connects to all the slices (e.g., NSSF, UDM, AUSF, SCP) and/or can serve all the slices. Along with the key and key identifier, the Initial AMF also stores its own AMF address, the associated target AMF address or the set of target AMF addresses or the target AMF set identifier (retrieved in earlier steps), as well as the Registration Request that caused the re-allocation.

In Steps 14 and 15, the Initial AMF includes the key identifier/token and potentially other parameters (e.g., timestamp, Uplink/Downlink NAS COUNTs, AMF address(es) for the initial and target AMF(s)) in the forwarding of the protected 5G NAS security context container.

In step 15a, the Target AMF selected by the RAN uses the supplied key identifier as well as its own target AMF address and the full Registration Request to retrieve one or more keys for decryption and/or integrity protection from the NF. The Target AMF also provides to the NF the other supplied parameters in Steps 14 and 15. The NF selects the stored information based on the key identifier/token and compares the target AMF address with the address supplied by the Initial AMF. It also compares the RR with the stored RR. If all these verifications match, then the NF provides the one or more requested keys to the Target AMF. The NF may remove the information supplied in step 11b after the Target AMF retrieves it.

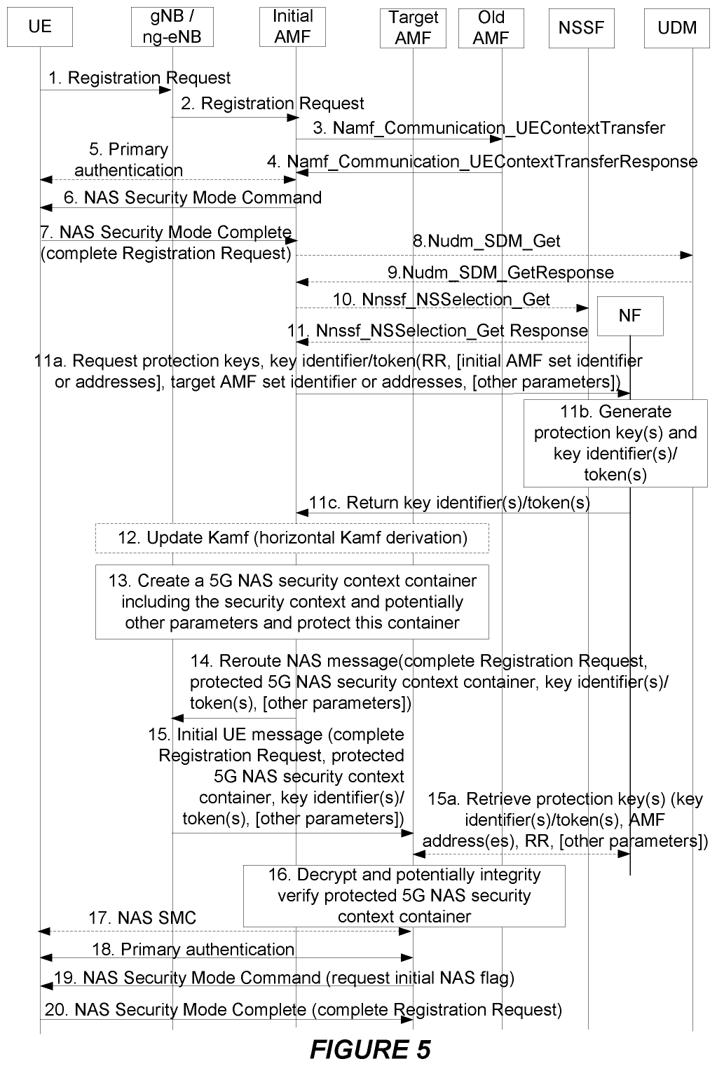

Consider lastly another embodiment that utilizes symmetric cryptography, whereby the Initial AMF requests another network node to generate the key(s) used to protect the security context. As shown in FIG. 5, the Initial AMF requests encryption/integrity key(s) and key identifier(s) from an NF that connects to and/or serves all the slices (e.g., NSSF, UDM, AUSF) providing the RR and the AMF address(es) of the initial and/or target AMF(s) or identifier of the AMF set (as well as other parameters such as timestamp, UE identifiers) in Step 11a. The NF stores the associated target AMF address or the set of target AMF addresses or the target AMF set identifier (retrieved in earlier steps as per legacy AMF re-allocation) as well as the Registration Request that caused the re-allocation and other parameters.

In Step 11b, the NF generates the key(s) and the key identifier(s)/token(s) based on one or more of the provided parameters (RR, target AMF address(es) of the initial and/or target AMF(s), other parameters). The key(s) can also be generated and stored per UE (per Subscription Permanent Identifier, SUPI) if the Initial AMF provides the SUPI as input.

In Step 11c, the NF and provides the key(s) and key identifier(s)/token(s) to the Initial AMF.

In Steps 14 and 15, the Initial AMF includes the key identifier(s)/token(s) and potentially other parameters (e.g., timestamp, Uplink/Downlink NAS COUNTs, AMF address(es) of the initial AMF and/or target AMF) in the forwarding of the protected 5G NAS security context container.

In step 15a, the Target AMF selected by the RAN uses the supplied key identifier(s) as well as its own target AMF address and the full Registration Request to retrieve the decryption and/or integrity verification key(s) from the NF. The Target AMF also provides to the NF the other supplied parameters in Steps 14 and 15 as well as additional own parameters e.g. its own knowledge of the UE identifier if it has obtained it before (e.g. Identity request for a UE SUPI). The NF selects the stored information based on the key identifier(s)/token(s) and compares the target AMF address with the address supplied by the Initial AMF. It also compares the RR with the stored RR. The NF may also compare other supplied parameters in Step 11b and 15a for consistency. For example If a UE identifier was supplied in 11b and 15a the NF may retrieve the information that matches the UE identifier information in 11a. The NF may also use any time supplied information to perform decisions on whether to provide the key(s) to the Target AMF or not. If all these verifications match, then the NF provides the decryption and/or integrity verification key(s) to the Target AMF. The NF may also remove the information supplied in Step 11b after the Target AMF retrieves it.

In some embodiments, the NF that generates the key(s) used to protect the security context in FIG. XX5 is the NSSF. In this case, the 5G NAS security context is protected before being re-routed via the RAN together with the Registration Request (RR) message, with the protection utilizing the NSSF as a trusted NF by both the initial and the target AMF. The NSSF belongs to the operator who deploys different slices and is assumed to serve all the slices offered by the operator.

The initial AMF sends the security context to the target AMF encrypted so that that the AMF key is not exposed to the RAN node. Although that RAN node has access to all the parameters to retrieve the decryption key of the protected 5G NAS security context container, the RAN node cannot directly request the decryption since it does not have a direct service-based architecture (SBA) interface to the NSSF. The RAN node is allowed to connect to the core network only via the NGAP protocol specified in TS 38.413.

More particularly, in some embodiments where the NF is the NSSF, the initial AMF in Step 17 of FIG. XX5 protects the security context or the potentially horizontally derived security context with an encryption key generated by the NSSF. Then the initial AMF sends both the Registration Request (RR) and a protected 5G NAS security context container (includes the security context along with the keyAmfHDerivationInd indicator if needed and potentially UL/DL NAS COUNTs) to the target AMF via RAN.

In these embodiments, there is one more optional NAS SMC performed by the target AMF after the Registration Request message and the protected 5G NAS security context container including the AMF key (Kamf-0 or Kamf-1) has been re-routed via RAN. This optional NAS SMC is performed in order to take the new Kamf-1 key into use by the UE and target AMF (after the optional horizontal Kamf derivation of Kamf-0 to generate a new Kamf-1 in the initial AMF).

The optional horizontal Kamf derivation in the initial AMF provides backward security so the target AMF has no access to the Kamf-0 and its corresponding NAS key used between the UE and the initial AMF. The initial AMF has access of the new Kamf-1 key re-routed via RAN to the target AMF, but after the target AMF has taken the new Kamf-1 key into use with the UE by running a NAS SMC, the target AMF can initiate a new protected Authentication procedure with the UE in order to generate a new Kamf-2 key shared with the UE, which the initial AMF has no access to. By running a new NAS SMC procedure between target AMF and UE to take the new Kamf-2 key into use, forward security is provided.

These embodiments advantageously have no impact on the UE. With regard to the AMF, the initial AMF may need to perform horizontal Kamf derivation of the Kamf before forwarding the protected 5G NAS security context container together with the complete Registration Request message on the N2 interface to the RAN. The initial AMF needs to request for a protection key from the NSSF and process the NSSF response. The initial AMF needs to encrypt the 5G NAS security context and potentially other parameters and produce the protected 5G NAS security context container. The target AMF needs to decrypt the protected 5G NAS security context container. The target AMF may need to perform a NAS SMC procedure to take any potentially horizontally derived Kamf key into use before initiating a primary authentication. The target AMF also needs to perform an authentication request in order to produce its own security context.

With regard to the NSSF, the NSSF needs a new service to generate keys and key identifiers for the protection of the 5G NAS security context container of the initial AMF and provide the keys and key identifiers to the target AMF.

With regard to the RAN, the REROUTE NAS REQUEST message is defined in TS 38.413 and the initial AMF includes the INITIAL UE MESSAGE into the REROUTE NAS REQUEST message to RAN. The REROUTE NAS REQUEST message needs to be updated to include the protected 5G NAS security context container and potentially other parameters. Also the RAN needs to forward the protected 5G NAS security context container and potentially other parameters to the target AMF together with the INITIAL UE MESSAGE.

Consider now additional details regarding the steps in FIG. XX5 according to some embodiments where the NF is the NSSF:
Step 1. The UE prepares a Registration Request message including a SUCI or 5G-GUTI and slicing information which could potentially cause an AMF re-allocation. If the UE has a 5G NAS security context (Registration with 5G-GUTI) it includes a protected NAS container in the Registration Request message.
Step 2. The RAN selects and forwards the RR message to an initial AMF.

Steps 3-4. These steps may only take place if UE has indicated its 5G-GUTI in the Registration Request message and if there is connectivity between the initial AMF and the old AMF. The initial AMF contacts the old AMF and requests the 5G NAS security context from the old AMF. The old AMF may perform horizontal Kamf derivation of the Kamf key. If there is no connectivity between the initial AMF and the old AMF and the UE has indicated its 5G-GUTI in the Registration Request message, then steps 3 and 4 are skipped and the initial AMF requests the UE identity SUCI from the UE in step 5 and then initiates primary authentication in step 6.

Although not shown, the initial AMF may perform an Identity Request for a SUCI towards the UE.
Step 5. The initial AMF may initiate a new primary authentication. This step is optional. This step is needed if the UE has indicated its SUCI in the Registration Request message.
Step 6. The initial AMF initiates a NAS SMC. This step takes place if a prior primary authentication has taken place or if the old AMF has performed horizontal Kamf derivation of the Kamf key. The initial AMF may include the request to the UE to include the complete Registration Request message by setting the flag “request initial NAS flag” if the old AMF has performed horizontal Kamf derivation of the Kamf key or the Registration Request included the UE SUCI.
Step 7. The UE includes the complete RR message sent in step 1 in the NAS Security Mode Complete message. The RR message is both integrity protected and encrypted.
Step 8. If the initial AMF needs UE's subscription information to decide whether to reroute the Registration Request and UE's slice selection subscription information was not provided by old AMF, the AMF selects a UDM as described in TS 23.501 v16.7.0, clause 6.3.8. The initial AMF sends Nudm_SDM_Get to the UDM.
Step 9. The UDM responds to initial AMF with a Nudm_SDM_GetResponse. The AMF gets the Slice Selection Subscription data including Subscribed S-NSSAIs. The UDM responds with slice selection data to the initial AMF.
Step 10. If there is a need for slice selection, (see clause 5.15.5.2.1 of TS 23.501 v16.7.0), e.g. the initial AMF cannot serve all the S-NSSAI(s) from the Requested NSSAI permitted by the subscription information, the initial AMF invokes the Nnssf_NSSelection_Get service operation from the NSSF by including the Requested NSSAI.
Step 11. The NSSF performs the steps specified in point (B) in clause 5.15.5.2.1 of TS 23.501 v16.7.0. The NSSF responds to Nnssf_NSSelection_Get to the initial AMF.
Step 11a. The initial AMF decides to reroute the RR message to a target AMF via RAN. The initial AMF requests a protection key from the NSSF for the purpose of AMF re-allocation and provides the RR and the target AMF set or target AMF address(es) as input.
Step 11b. The NSSF uses one or more of the provided inputs in Step 11a to generate a key Kamfreal and a key identifier/token Kamfreal ID. The NSSF stores the key, key identifier/token and the provided input (RR, target AMF address(es)).
Step 11c. The NSSF responds with the Kamfreal and a key identifier/token Kamfreal ID.
Step 12. The initial AMF optionally performs horizontal Kamf derivation of Kamf-0 to generate a new Kamf-1. This step would ensure that the target AMF has no access to the Kamf-0 key used by the initial AMF. If the Initial AMF performs horizontal Kamf derivation then the initial AMF resets the corresponding uplink and downlink NAS COUNTs.
Step 13. The initial AMF encrypts the security context (including Kamf-0 or Kamf-1), the keyAmfHDerivationInd indicator and potentially other parameters (e.g. UL/DL NAS COUNTs if horizontal key derivation was performed in Step 16) with the Kamfreal and creates a protected 5G NAS security context container.
Step 14. The initial AMF forwards the complete Registration Request message, the protected 5G NAS security context container, the Kamfreal ID and potentially other parameters (e.g. AMF address(es)) to the RAN.
Step 15. The RAN forwards the complete Registration Request message, the protected 5G NAS security context container, the Kamfreal ID to the target AMF.
Step 15a. The target AMF requests the protection key Kamfreal from the NSSF by providing the its own address, the RR, and the Kamfreal ID to the NSSF. The NSSF verifies that the target AMF is included in the target AMF set or its address matches one of the target AMF addresses provided by the initial AMF. If the verification is successful the NSSF returns the protection key Kamfreal to the target AMF and deletes the Kamfreal and Kamfreal ID.
Step 16. The target AMF decrypts the protected 5G NAS security context container.

After decrypting the security context, if SUCI is included in the Registration Request, the target AMF skips context retrieval from the old AMF (as no additional information about established PDU sessions etc. is stored in the old AMF). If a 5G-GUTI is included in the Registration Request and the target AMF has received a 5G NAS security context and potentially a keyAmfHDerivationInd indicator, then: (i) if there is no connectivity between the target AMF and old AMF, the target AMF skips context retrieval from the old AMF (as any additional information about established PDU sessions etc. stored in the old AMF cannot be retrieved by the target AMF); and (ii) if there is connectivity between the target AMF and the old AMF, the target AMF can fetch any additional information about established PDU sessions etc. stored in the old AMF.
Step 17. If the target AMF has received the keyAmfHDerivationInd indicator, then the target AMF shall run a NAS SMC procedure with the UE, to take the new Kamf-1 key into use with the UE.
Step 18. The target AMF needs to initiate a new primary authentication with the UE to generate a new Kamf-2. The new primary authentication procedure is protected by the Kamf-1. This step would ensure that the initial AMF has no access to the new Kamf-2 key generated between target AMF and the UE. The target AMF determines that a NAS re-route via RAN has taken place and the target AMF shall use the Kamf-1 only for the purpose of sending protected NAS Security Mode Command and Authentication Challenge/Request to the UE, and for receiving protected NAS Security Mode Complete and Authentication Response from the UE.
Steps 19-20. The target AMF needs to run a new NAS SMC procedure with the UE to take the new Kamf-2 into use with the UE. The target AMF needs to include the request to the UE to include the complete Registration Request message in the NAS Security Mode Complete message by setting the flag “request initial NAS flag” in the NAS Security Mode Command message. The UE includes the complete Registration Request message (sent in step 1) in the NAS Security Mode Complete message to the target AMF. This means that the target AMF can take the Registration Request message received in NAS Security Mode Complete message into use and drop the Registration Request message rerouted via RAN.

Note that, as used herein, secure transport is achieved by confidentiality/ciphering and integrity protection. Confidentiality/ciphering in this context means encryption of messages, which makes it infeasible for unauthorized parties to decrypt and read the original message. Integrity protection in this context means the sender adding a security token or a message authentication code (MAC) to the message that the receiver can verify, which makes it infeasible for unauthorized parties to tamper with the original message without the receiver detecting the tampering.

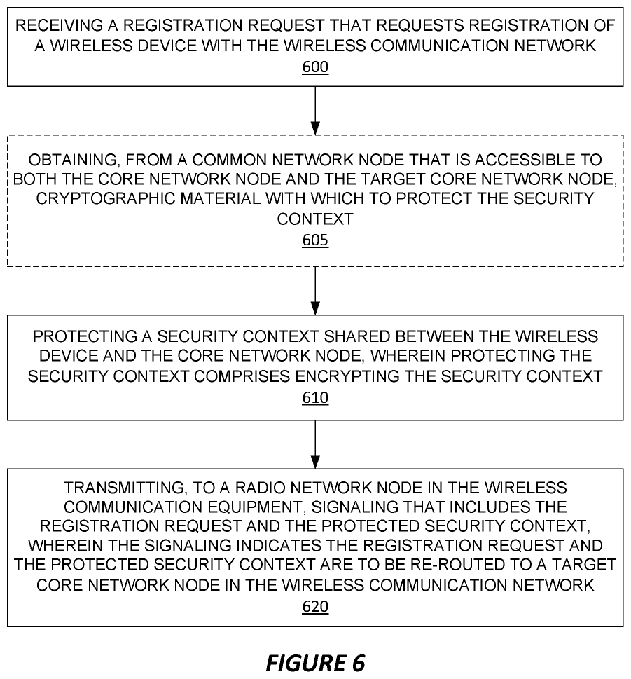

In view of the above modifications and variations, FIG. 6 depicts a method performed by the (initial) CN node 16 in the wireless communication network 10 of FIG. 1 in accordance with particular embodiments. The method includes receiving a registration request 14 that requests registration of a wireless device 12 with the wireless communication network 10 (Block 600). The method also includes protecting a security context 20 shared between the wireless device 12 and the core network node 16 (Block 610). In some embodiments, protecting the security context 20 comprises encrypting the security context 20. The method also comprises transmitting, to a radio network node 23 in the wireless communication network 10, signaling 24 that includes the registration request 14 and the protected security context 20P (Block 620). In some embodiments, the signaling 24 indicates the registration request 14 and the protected security context 20P are to be re-routed to a target CN node 18 in the wireless communication network 10.

In some embodiments, protecting the security context (Block 610) comprises protecting the security context with cryptographic material that is specific to the target core network node or to a target core network node set to which the target core network node belongs. Additionally or alternatively, protecting the security context (Block 610) comprises protecting the security context with cryptographic material that is shared between the core network node and the target core network node or is shared between the core network node and a target core network node set to which the target core network node belongs.

In some embodiments, the method further comprises obtaining, from a common network node that is accessible to both the core network node and the target core network node, cryptographic material with which to protect the security context (Block 605). In some embodiments, the common network node implements a network slice selection function, NSSF, and serves multiple network slices of the wireless communication network.

In some embodiments, obtaining the cryptographic material (Block 605) comprises transmitting, to the common network node, a request for the cryptographic material and for a cryptographic material reference associated with the cryptographic material, and then receiving the cryptographic material and the cryptographic material reference in response to the request. In some embodiments, the signaling transmitted to the radio network node further includes the cryptographic material reference. The cryptographic material reference may for example comprise an identifier of the cryptographic material or comprises a token specific to the cryptographic material.

In some embodiments, the request for the cryptographic material and for the cryptographic material reference includes an identifier or address of the target core network node, or an identifier or address of a target core network node set to which the target core network node belongs. Additionally or alternatively, the request includes an identifier or address of the core network node, or an identifier or address of a core network node set to which the core network node belongs. Additionally or alternatively, the request includes an identifier that identifies the wireless device or identifies a subscription associated with the wireless device. Additionally or alternatively, the request includes the registration request.

In some embodiments, the signaling further includes one or more parameters. In some embodiments, at least one of the one or more parameters is associated with the registration request. In other embodiments, at least one of the one or more parameters additionally or alternatively is associated with a procedure for the radio network node to route the registration request to the target core network node. Additionally or alternatively, at least one of the one or more parameters is associated with cryptographic material usable by the target core network node to decrypt and/or verify an integrity of the protected security context. In some embodiments, the method further comprises packaging the security context and the one or more parameters into a container. In some embodiments, protecting the security context comprises protecting the container. In some embodiments, the signaling includes the protected container. In one or more of these embodiments, the one or more parameters include an uplink or downlink non-access stratum count value. In other embodiments, the one or more parameters alternatively or additionally include a horizontal key derivation indicator that indicates whether or not the core network node has performed horizontal key derivation to derive a cryptographic key included in the security context. Additionally or alternatively, the one or more parameters may include a timestamp usable to verify a validity of cryptographic material usable by the target core network node to decrypt and/or verify an integrity of the protected security context. Additionally or alternatively, the one or more parameters may include an address of the target core network node.

In some embodiments, the core network node implements an access and mobility function, AMF. In some embodiments, the target core network node implements a target AMF.

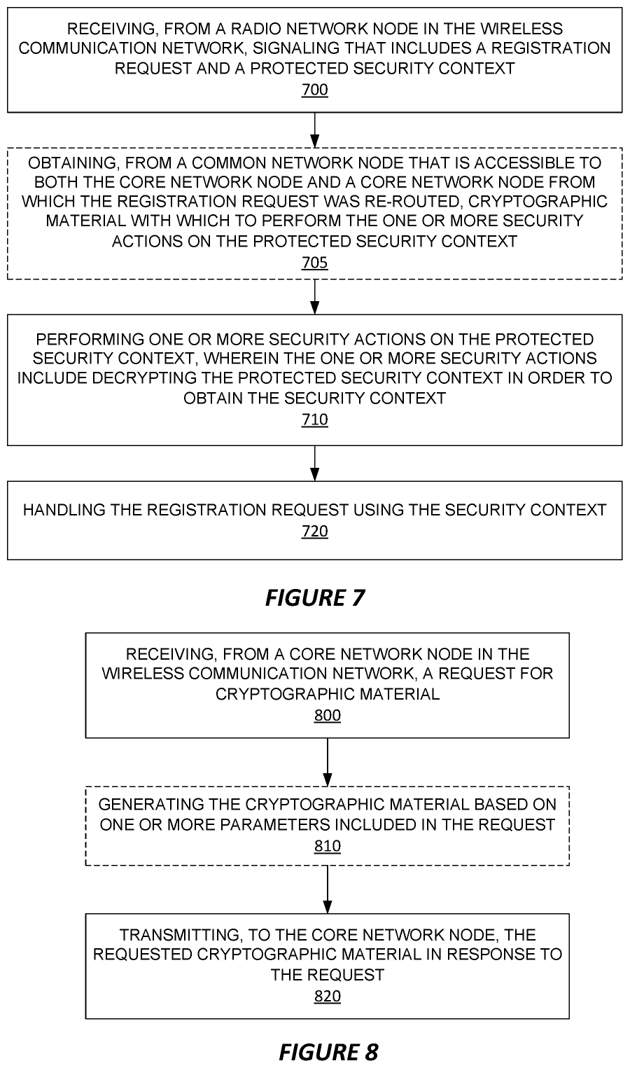

FIG. 7 depicts a method performed by the (target) CN node 18 in the wireless communication network 10 of FIG. 1 in accordance with other particular embodiments. The method includes receiving, from a radio network node 23 in the wireless communication network 10, signaling 26 that includes a registration request 14 and a protected security context 20P (Block 700). In some embodiments, the registration request 14 requests registration of a wireless device 12 with the wireless communication network 10. The protected security context 20P may comprises a security context protected with encryption in some embodiments. This security context is shared between the wireless device 12 and another core network node 16, e.g., initial CN node 16 in FIG. 1. Regardless, the method further comprises performing one or more security actions on the protected security context 20P (Block 710). For example, the one or more security actions may include decrypting the protected security context 20P in order to obtain the security context 20. The method also comprises handling the registration request 14 using the security context 20 (Block 720).

In some embodiments, performing one or more security actions on the protected security context (Block 710) comprises performing one or more security actions on the protected security context with cryptographic material that is specific to the core network node or to a core network node set to which the core network node belongs. Additionally or alternatively, performing one or more security actions on the protected security context (Block 710) comprises performing one or more security actions on the protected security context with cryptographic material that is shared between the core network node and another core network node from which the registration request was re-routed or is shared between a core network node set to which the core network node belongs and another core network node from which the registration request was re-routed.

In some embodiments, the method further comprises obtaining, from a common network node that is accessible to both the core network node and a core network node from which the registration request was re-routed, cryptographic material with which to perform the one or more security actions on the protected security context (Block 705). In one or more of these embodiments, the common network node implements a network slice selection function, NSSF, and serves multiple network slices of the wireless communication network.

In one or more of these embodiments, obtaining the cryptographic material (Block 705) comprises transmitting, to the common network node, a request for the cryptographic material and receiving the cryptographic material in response to the request. In some embodiments, the request includes a cryptographic material reference associated with the cryptographic material, e.g., where the cryptographic material reference may comprise an identifier of the cryptographic material or comprises a token specific to the cryptographic material. In some embodiments, the cryptographic material reference is included in the signaling received from the radio network node. Additionally or alternatively, the request includes an identifier or address of the core network node, or an identifier or address of a core network node set to which the core network node belongs. Additionally or alternatively, the request includes the registration request.

In some embodiments, the signaling further includes one or more parameters. In some embodiments, at least one of the one or more parameters is associated with the registration request or is associated with cryptographic material usable by the target core network node to decrypt and/or verify an integrity of the protected security context. In some embodiments, receiving the signaling including the protected security context comprises receiving a protected container that includes the security context and the one or more parameters. In some embodiments, performing one or more security actions on the protected security context comprises performing the one or more security actions on the protected container. In one or more of these embodiments, the one or more parameters include an uplink or downlink non-access stratum count value. Additionally or alternatively, in other embodiments, the one or more parameters include a horizontal key derivation indicator that indicates whether or not the another core network node has performed horizontal key derivation to derive a cryptographic key included in the security context. Additionally or alternatively, in other embodiments, the one or more parameters include a timestamp usable to verify a validity of cryptographic material usable by the core network node to decrypt and/or verify an integrity of the protected security context.

In some embodiments, the core network node implements an access and mobility function, AMF.

FIG. 8 shows a method performed by a (common) network node 30 in a wireless communication network 10 according to other embodiments. The method as shown comprises receiving, from a core network node 16 or 18 in the wireless communication network 10, a request for cryptographic material (Block 800). The method may also comprise transmitting, to the core network node 16 or 18, the requested cryptographic material in response to the request (Block 820).

In some embodiments, the request includes one or more parameters. In some embodiments, the one or more parameters comprise an identifier or address of the core network node and/or an identifier or address of a core network node set to which the core network node belongs. Additionally or alternatively, the one or more parameters comprise an identifier or address of another core network node with which the cryptographic material is to be shared, and/or an identifier or address of another core network node set to which said another core network node belongs. Alternatively or additionally, the one or more parameters comprise an identifier that identifies a wireless device or identifies a subscription associated with the wireless device. Additionally or alternatively, the one or more parameters comprise a registration request requesting registration of the wireless device with the wireless communication network. In these and other embodiments, the method may also comprise generating the requested cryptographic material based on at least one of the one or more parameters included in the request (Block 810).

More specifically, in some embodiments, the request includes three or more parameters. In some embodiments, the three or more parameters comprise at least: (i) an identifier or address of the core network node or an identifier or address of a core network node set to which the core network node belongs; (ii) an identifier or address of another core network node with which the cryptographic material is to be shared, or an identifier or address of another core network node set to which said another core network node belongs; and (iii) a registration request requesting registration of the wireless device with the wireless communication network. In these and other embodiments, the method may comprise generating the requested cryptographic material based on the three or more parameters included in the request.

In some embodiments, the cryptographic material is specific to the core network node or to a core network node set to which the core network node belongs.

In some embodiments, the method further comprises transmitting, to the core network node, a cryptographic material reference associated with the cryptographic material in response to the request. In some embodiments, the cryptographic material reference comprises an identifier of the cryptographic material or comprises a token specific to the cryptographic material.

In some embodiments, the network node implements a network slice selection function, NSSF, and serves multiple network slices of the wireless communication network.

In some embodiments, the core network node implements an access and mobility function, AMF.

Embodiments herein also include corresponding apparatuses. Embodiments herein for instance include a wireless device configured to perform any of the steps of any of the embodiments described above for the wireless device.

Embodiments also include a core network node 16 or 18 comprising processing circuitry and power supply circuitry. The processing circuitry is configured to perform any of the steps of any of the embodiments described above for the core network node 16 or 18. The power supply circuitry is configured to supply power to the core network node 16 or 18.

Embodiments further include a core network node 16 or 18 comprising processing circuitry. The processing circuitry is configured to perform any of the steps of any of the embodiments described above for the core network node 16 or 18. In some embodiments, the core network node 16 or 18 further comprises communication circuitry.

Embodiments further include a core network node 16 or 18 comprising processing circuitry and memory. The memory contains instructions executable by the processing circuitry whereby the core network node 16 or 18 is configured to perform any of the steps of any of the embodiments described above for the core network node 16 or 18.

Embodiments herein also include a network node 30 configured to perform any of the steps of any of the embodiments described above for the network node 30.

Embodiments also include a network node 30 comprising processing circuitry and power supply circuitry. The processing circuitry is configured to perform any of the steps of any of the embodiments described above for the network node 30. The power supply circuitry is configured to supply power to the network node 30.

Embodiments further include a network node 30 comprising processing circuitry. The processing circuitry is configured to perform any of the steps of any of the embodiments described above for the network node 30. In some embodiments, the network node 30 further comprises communication circuitry.

Embodiments further include a network node 30 comprising processing circuitry and memory. The memory contains instructions executable by the processing circuitry whereby the network node 30 is configured to perform any of the steps of any of the embodiments described above for the network node 30.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

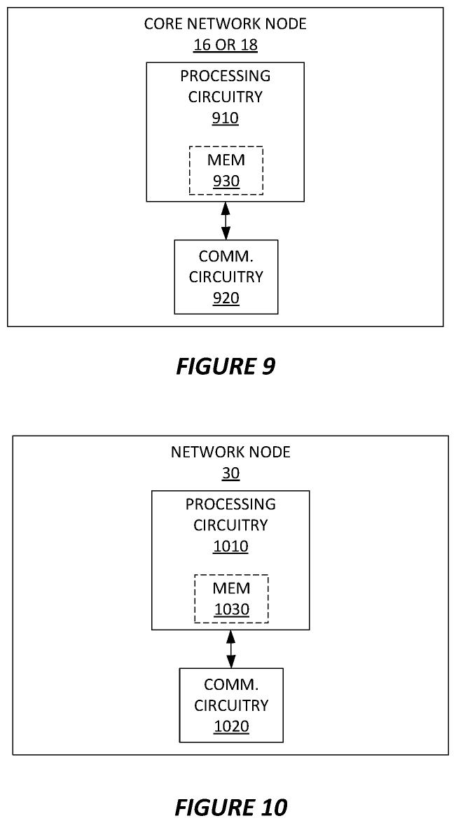

FIG. 9 for example illustrates a core network node 16 or 18 as implemented in accordance with one or more embodiments. As shown, the core network node 16 or 18 includes processing circuitry 910 and communication circuitry 920. The communication circuitry 920 is configured to transmit and/or receive information to and/or from one or more other nodes, e.g., via any communication technology. The processing circuitry 910 is configured to perform processing described above, e.g., in FIG. 6 or 7, such as by executing instructions stored in memory 930. The processing circuitry 910 in this regard may implement certain functional means, units, or modules.

FIG. 10 illustrates a network node 30 as implemented in accordance with one or more embodiments. As shown, the network node 30 includes processing circuitry 1010 and communication circuitry 1020. The communication circuitry 1020 is configured to transmit and/or receive information to and/or from one or more other nodes, e.g., via any communication technology. The processing circuitry 1010 is configured to perform processing described above, e.g., in FIG. 8, such as by executing instructions stored in memory 1030. The processing circuitry 1010 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

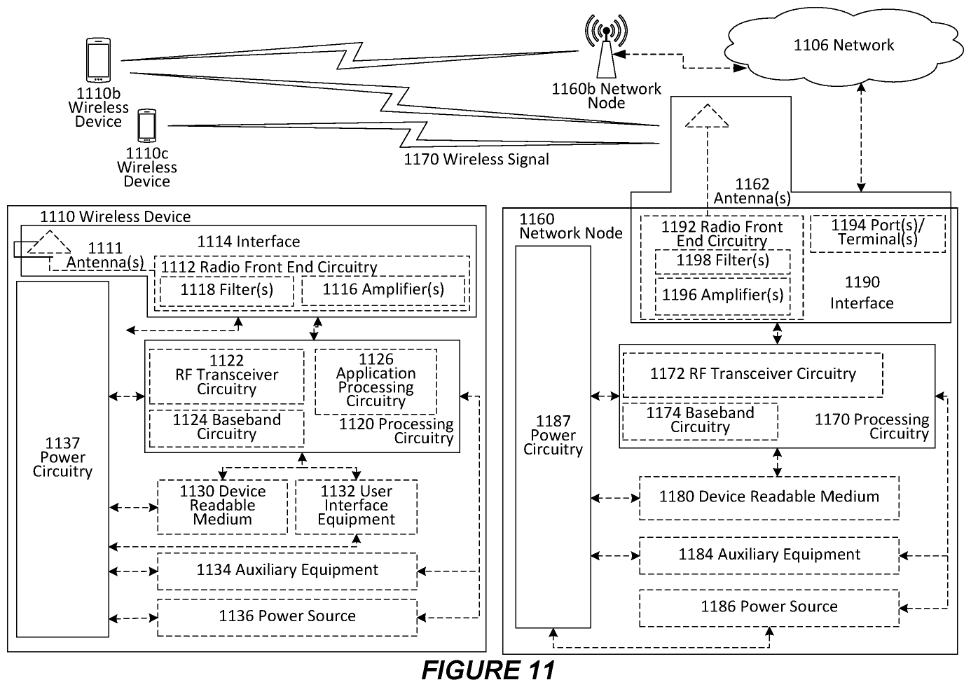

Although the subject matter described herein may be implemented in any appropriate type of system using any suitable components, the embodiments disclosed herein are described in relation to a wireless network, such as the example wireless network illustrated in FIG. 11. For simplicity, the wireless network of FIG. 11 only depicts network 1106, network nodes 1160 and 1160b, and WDs 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 11, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 11 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units

In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signalling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 11 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

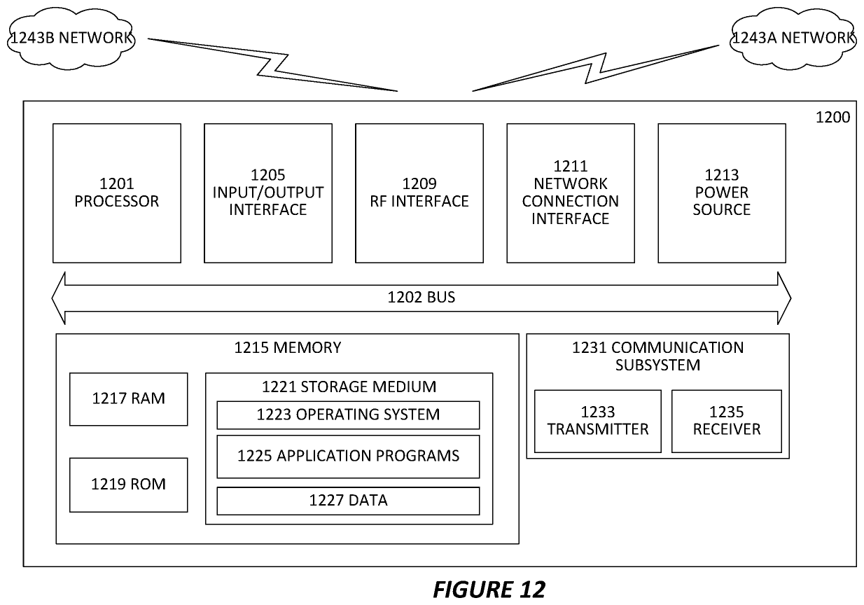

FIG. 12 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 12200 may be any UE identified by the 3^{rd} Generation Partnership Project (3GPP), including a NB-IoT UE, a machine type communication (MTC) UE, and/or an enhanced MTC (eMTC) UE. UE 1200, as illustrated in FIG. 12, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 12 is a UE, the components discussed herein are equally applicable to a WD, and vice-versa.

In FIG. 12, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 12, or only a subset of the components. The level of integration between the components may vary from one UE to another UE. Further, certain UEs may contain multiple instances of a component, such as multiple processors, memories, transceivers, transmitters, receivers, etc.

In FIG. 12, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 12, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 12, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

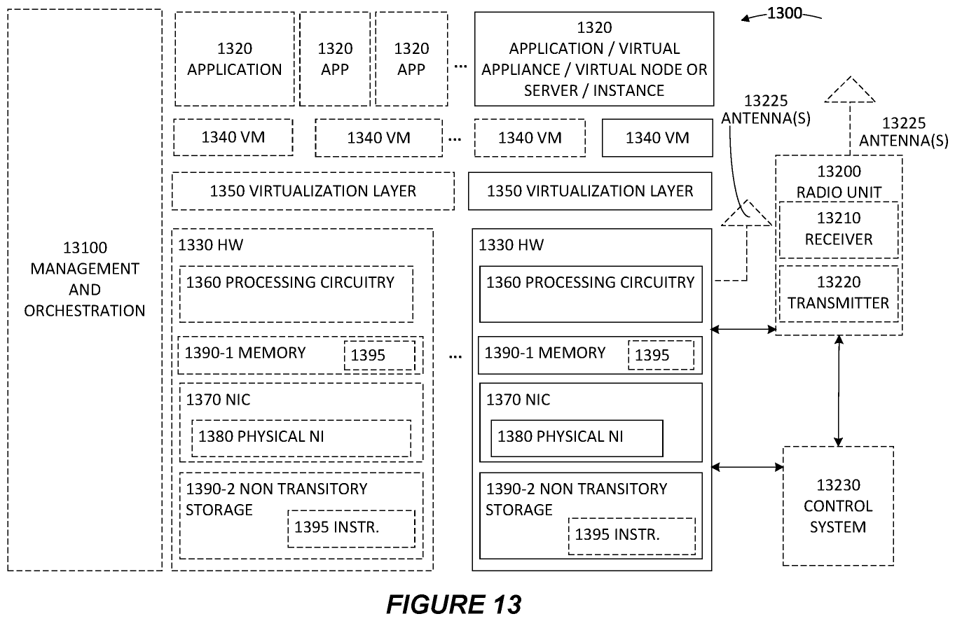

FIG. 13 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 13, hardware 1330 may be a standalone network node with generic or specific components. Hardware 1330 may comprise antenna 13225 and may implement some functions via virtualization. Alternatively, hardware 1330 may be part of a larger cluster of hardware (e.g. such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 13.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signalling can be effected with the use of control system 13230 which may alternatively be used for communication between the hardware nodes 1330 and radio units 13200.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Notably, modifications and other embodiments of the present disclosure will come to mind to one skilled in the art having the benefit of the teachings presented in the foregoing descriptions and the associated drawings. Therefore, it is to be understood that the disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a core network node in a wireless communication network, the method comprising:
   receiving a registration request that requests registration of a wireless device with the wireless communication network;
   protecting a security context shared between the wireless device and the core network node, wherein protecting the security context comprises encrypting the security context; and
   transmitting, to a radio network node in the wireless communication network, signaling that includes the registration request and the protected security context, wherein the signaling indicates the registration request and the protected security context are to be re-routed to a target core network node in the wireless communication network.
A2. The method of embodiment A1, wherein protecting the security context comprises protecting the security context with cryptographic material that:
   is specific to the target core network node or to a target core network node set to which the target core network node belongs; and/or
   is shared between the core network node and the target core network node or is shared between the core network node and a target core network node set to which the target core network node belongs.
A3. The method of embodiment A2, wherein the cryptographic material is a public key included in a set of keys assigned to the target core network node or to the target core network node set, wherein the set of keys included the public key and a corresponding private key.
A4. The method of any of embodiments A1-A3, further comprising obtaining, from a common network node that is accessible to both the core network node and the target core network node, cryptographic material with which to protect the security context.
A5. The method of embodiment A4, wherein said obtaining comprises:
   transmitting, to the common network node, a request for the cryptographic material and for a cryptographic material reference associated with the cryptographic material, wherein the request includes at least one of any one or more of:
      an identifier or address of the target core network node;
      an identifier or address of a target core network node set to which the target core network node belongs;
      an identifier that identifies the wireless device or identifies a subscription associated with the wireless device; and
      the registration request; and
   receiving the cryptographic material and the cryptographic material reference in response to the request;
   wherein the signaling transmitted to the radio network node further includes the cryptographic material reference, wherein the cryptographic material reference comprises an identifier of the cryptographic material or comprises a token specific to the cryptographic material.
A6. The method of any of embodiments A1-A2, further comprising:
   generating cryptographic material with which to protect the security context; and
   transmitting, to a common network node that is accessible to both the core network node and the target core network node, the cryptographic material and information indicating the cryptographic material is associated with the target core network node and/or associated with the registration request.
A7. The method of embodiment A6, wherein a cryptographic material reference is associated with the cryptographic material, wherein the cryptographic material reference comprises an identifier of the cryptographic material or comprises a token specific to the cryptographic material, wherein the information associates the cryptographic material reference with an identifier or address of the target core network node, with an identifier or address of a target core network node set to which the target core network node belongs, and/or with the content of the registration request, wherein the signaling transmitted to the radio network node further includes the cryptographic material reference.
A8. The method of any of embodiments A4-A7, wherein the common network node serves multiple network slices of the wireless communication network.
A9. The method of any of embodiments A4-A8, wherein the common network node implements a network slice selection function, a unified data management, a service communication proxy, or an authentication server function.
A10. The method of any of embodiments A1-A9, wherein the security context is to be re-routed by the radio network node to any one of multiple target core network nodes, wherein the core network node shares different respective cryptographic material with different target core network nodes, wherein protecting the security context comprises protecting multiple copies of the security context using the different respective cryptographic material, and wherein the signaling includes the multiple protected copies of the security context.
A11. The method of embodiment A10, wherein the signaling indicates, for each of the multiple protected copies of the security context, to which of the multiple target core network nodes the protected copy is targeted.
A12. The method of any of embodiments A1-A11, wherein the signaling further includes one or more parameters, wherein at least one of the one or more parameters is associated with the registration request, is associated with a procedure for the radio network node to route the registration request to the target core network node, or is associated with cryptographic material usable by the target core network node to decrypt and/or verify an integrity of the protected security context.
A13. The method of embodiment A12, wherein the one or more parameters include at least one of any one or more of:
   an uplink or downlink non-access stratum count value;
   a horizontal key derivation indicator that indicates whether or not the core network node has performed horizontal key derivation to derive a cryptographic key included in the security context;
   a timestamp usable to verify a validity of cryptographic material usable by the target core network node to decrypt and/or verify an integrity of the protected security context; and
   an address of the target core network node.
A14. The method of any of embodiments A12-A13, further comprising packaging the security context and the one or more parameters into a container, wherein protecting the security context comprises protecting the container, and wherein the signaling includes the protected container.
A15. The method of any of embodiments A1-A14, wherein the security context includes cryptographic material.
A16. The method of any of embodiments A1-A15, wherein the core network node implements an access and mobility function, AMF, and wherein the target core network node implements a target AMF.
A17. The method of any of embodiments A1-A16, wherein protecting the security context further comprises integrity protecting the security context.

### Group B Embodiments

B1. A method performed by a core network node in a wireless communication network, the method comprising:
   receiving, from a radio network node in the wireless communication network, signaling that includes a registration request and a protected security context, wherein the registration request requests registration of a wireless device with the wireless communication network, wherein the protected security context comprises a security context protected with encryption, wherein the security context is shared between the wireless device and another core network node;
   performing one or more security actions on the protected security context, wherein the one or more security actions include decrypting the protected security context in order to obtain the security context; and
   handling the registration request using the security context.
B2. The method of embodiment B1, wherein performing one or more security actions on the protected security context comprises performing one or more security actions on the protected security context with cryptographic material that:
   is specific to the core network node or to a core network node set to which the core network node belongs; and/or
   is shared between the core network node and another core network node from which the registration request was re-routed or is shared between a core network node set to which the core network node belongs and another core network node from which the registration request was re-routed.
B3. The method of embodiment B2, wherein the cryptographic material is a private key included in a set of keys assigned to the core network node or to the core network node set, wherein the set of keys included the private key and a corresponding public key.
B4. The method of any of embodiments B1-B3, further comprising obtaining, from a common network node that is accessible to both the core network node and a core network node from which the registration request was re-routed, cryptographic material with which to perform the one or more security actions on the protected security context.
B5. The method of embodiment B4, wherein said obtaining comprises:
   transmitting, to the common network node, a request for the cryptographic material, wherein the request includes at least one of any one or more of:
      a cryptographic material reference associated with the cryptographic material;
      an identifier or address of the core network node;
      an identifier or address of a core network node set to which the core network node belongs;
      an identifier that identifies the wireless device or identifies a subscription associated with the wireless device; and
      the registration request; and
   receiving the cryptographic material in response to the request;
   wherein the received signaling further includes the cryptographic material reference, wherein the cryptographic material reference comprises an identifier of the cryptographic material or comprises a token specific to the cryptographic material.
B6. The method of any of embodiments B4-B5, wherein the common network node serves multiple network slices of the wireless communication network.
B7. The method of any of embodiments B4-B6, wherein the common network node implements a network slice selection function, a unified data management, a service communication proxy, or an authentication server function.
B8. The method of any of embodiments B1-B7, wherein the signaling further includes one or more parameters, wherein at least one of the one or more parameters is associated with the registration request or is associated with cryptographic material usable by the target core network node to decrypt and/or verify an integrity of the protected security context.
B9. The method of embodiment B8, wherein the one or more parameters include at least one of any one or more of:
   an uplink or downlink non-access stratum count value;
   a horizontal key derivation indicator that indicates whether or not the another core network node has performed horizontal key derivation to derive a cryptographic key included in the security context; and
   a timestamp usable to verify a validity of cryptographic material usable by the core network node to decrypt and/or verify an integrity of the protected security context.
B10. The method of any of embodiments B8-B9, wherein receiving the signaling including the protected security context comprises receiving a protected container that includes the security context and the one or more parameters, wherein performing one or more security actions on the protected security context comprises performing the one or more security actions on the protected container.
B11. The method of any of embodiments B1-B10, wherein the security context includes cryptographic material.
B12. The method of any of embodiments B1-B111, wherein the core network node implements an access and mobility function, AMF.
B13. The method of any of embodiments B1-B12, wherein the one or more security actions further include verifying an integrity of the protected security context.

### Group X Embodiments

X1. A method performed by a network node in a wireless communication network, the method comprising:
   receiving, from a core network node in the wireless communication network, a request for cryptographic material, wherein the request includes at least one of any one or more of:
      an identifier or address of the core network node;
      an identifier or address of a core network node set to which the core network node belongs;
      an identifier that identifies a wireless device or identifies a subscription associated with the wireless device; and
      a registration request requesting registration of the wireless device with the wireless communication network; and
   transmitting, to the core network node, the requested cryptographic material in response to the request.
X2. The method of embodiment X1, wherein the cryptographic material is specific to the core network node or to a core network node set to which the core network node belongs.
X3. The method of any of embodiments X1-X2, further comprising generating the cryptographic material based on one or more parameters included in the request, and wherein the method further comprises transmitting, to the core network node, a cryptographic material reference associated with the cryptographic material in response to the request, wherein the cryptographic material reference comprises an identifier of the cryptographic material or comprises a token specific to the cryptographic material.
X4. The method of any of embodiments X1-X3, wherein the network node serves multiple network slices of the wireless communication network.
X5. The method of any of embodiments X1-X4, wherein the network node implements a network slice selection function, a unified data management, a service communication proxy, or an authentication server function.
X6. The method of any of embodiments X1-X5, wherein the core network node implements an access and mobility function, AMF.

### Group C Embodiments

C1. A core network node configured to perform any of the steps of any of the Group A or Group B embodiments.
C2. A core network node comprising processing circuitry configured to perform any of the steps of any of the Group A or Group B embodiments.
C3. A core network node comprising:
   communication circuitry; and
   processing circuitry configured to perform any of the steps of any of the Group A or Group B embodiments.
C4. A core network node comprising:
   processing circuitry configured to perform any of the steps of any of the Group A or Group B embodiments; and
   power supply circuitry configured to supply power to the core network node.
C5. A core network node comprising:
   processing circuitry and memory, the memory containing instructions executable by the processing circuitry whereby the core network node is configured to perform any of the steps of any of the Group A or Group B embodiments.
C6. A computer program comprising instructions which, when executed by at least one processor of a core network node, causes the core network node to carry out the steps of any of the Group A or Group B embodiments.
C8. A carrier containing the computer program of embodiment C7, wherein the carrier is one of an electronic signal, optical signal, radio signal, or computer readable storage medium.
C9. A network node configured to perform any of the steps of any of the Group X embodiments.
C10. A network node comprising processing circuitry configured to perform any of the steps of any of the Group X embodiments.
C11. A network node comprising:
   communication circuitry; and
   processing circuitry configured to perform any of the steps of any of the Group X embodiments.
C12. A network node comprising:
   processing circuitry configured to perform any of the steps of any of the Group X embodiments;
   power supply circuitry configured to supply power to the network node.
C13. A network node comprising:
   processing circuitry and memory, the memory containing instructions executable by the processing circuitry whereby the network node is configured to perform any of the steps of any of the Group X embodiments.
C14. A computer program comprising instructions which, when executed by at least one processor of a network node, causes the network node to carry out the steps of any of the Group X embodiments.
C15. A carrier containing the computer program of any of embodiments C15-C16, wherein the carrier is one of an electronic signal, optical signal, radio signal, or computer readable storage medium.

1.-32. (canceled)

33. A method performed by a core network node in a wireless communication network, the method comprising:
receiving a registration request that requests registration of a wireless device with the wireless communication network;
protecting a security context shared between the wireless device and the core network node, wherein protecting the security context comprises encrypting the security context; and
transmitting, to a radio network node in the wireless communication network, signaling that includes the registration request and the protected security context, wherein the signaling indicates the registration request and the protected security context are to be re-routed to a target core network node in the wireless communication network.

34. The method of claim 33, wherein protecting the security context comprises protecting the security context with cryptographic material that:
is specific to the target core network node or to a target core network node set to which the target core network node belongs; and/or
is shared between the core network node and the target core network node or is shared between the core network node and a target core network node set to which the target core network node belongs.

35. The method of claim 33, further comprising obtaining, from a common network node that is accessible to both the core network node and the target core network node, cryptographic material with which to protect the security context.

36. The method of claim 35, wherein said obtaining comprises:
transmitting, to the common network node, a request for the cryptographic material and for a cryptographic material reference associated with the cryptographic material, wherein the request includes at least:
an identifier or address of the target core network node, or an identifier or address of a target core network node set to which the target core network node belongs;
an identifier or address of the core network node, or an identifier or address of a core network node set to which the core network node belongs; and
the registration request; and
receiving the cryptographic material and the cryptographic material reference in response to the request;
wherein the signaling transmitted to the radio network node further includes the cryptographic material reference, wherein the cryptographic material reference comprises an identifier of the cryptographic material or comprises a token specific to the cryptographic material.

37. The method of claim 35, wherein the common network node implements a network slice selection function (NSSF) and serves multiple network slices of the wireless communication network.

38. The method of claim 33, wherein the signaling further includes one or more parameters, wherein at least one of the one or more parameters is associated with the registration request, is associated with a procedure for the radio network node to route the registration request to the target core network node, or is associated with cryptographic material usable by the target core network node to decrypt and/or verify an integrity of the protected security context, and wherein the method further comprises packaging the security context and the one or more parameters into a container, wherein protecting the security context comprises protecting the container, and wherein the signaling includes the protected container.

39. The method of claim 38, wherein the one or more parameters include at least one of any one or more of:
an uplink or downlink non-access stratum count value;
a horizontal key derivation indicator that indicates whether or not the core network node has performed horizontal key derivation to derive a cryptographic key included in the security context;
a timestamp usable to verify a validity of cryptographic material usable by the target core network node to decrypt and/or verify an integrity of the protected security context; and
an address of the target core network node.

40. The method of claim 33, wherein the core network node implements an access and mobility function (AMF), and wherein the target core network node implements a target AMF.

41. The method of claim 33, wherein the core network node lacks a direct interface with the target core network node.

42. A method performed by a core network node in a wireless communication network, the method comprising:
receiving, from a radio network node in the wireless communication network, signaling that includes a registration request and a protected security context, wherein the registration request requests registration of a wireless device with the wireless communication network, wherein the protected security context comprises a security context protected with encryption, wherein the security context is shared between the wireless device and another core network node;
performing one or more security actions on the protected security context, wherein the one or more security actions include decrypting the protected security context in order to obtain the security context; and
handling the registration request using the security context.

43. The method of claim 42, wherein performing one or more security actions on the protected security context comprises performing one or more security actions on the protected security context with cryptographic material that:
is specific to the core network node or to a core network node set to which the core network node belongs; and/or
is shared between the core network node and another core network node from which the registration request was re-routed or is shared between a core network node set to which the core network node belongs and another core network node from which the registration request was re-routed.

44. The method of claim 42, further comprising obtaining, from a common network node that is accessible to both the core network node and a core network node from which the registration request was re-routed, cryptographic material with which to perform the one or more security actions on the protected security context.

45. The method of claim 44, wherein said obtaining comprises:
transmitting, to the common network node, a request for the cryptographic material, wherein the request includes at least:
a cryptographic material reference associated with the cryptographic material;
an identifier or address of the core network node, or an identifier or address of a core network node set to which the core network node belongs;
an identifier or address of the another core network node, or an identifier or address of another core network node set to which the another core network node belongs; and
the registration request; and
receiving the cryptographic material in response to the request;
wherein the received signaling further includes the cryptographic material reference, wherein the cryptographic material reference comprises an identifier of the cryptographic material or comprises a token specific to the cryptographic material.

46. The method of claim 44, wherein the common network node implements a network slice selection function (NSSF) and serves multiple network slices of the wireless communication network.

47. The method of claim 42, wherein the signaling further includes one or more parameters, wherein at least one of the one or more parameters is associated with the registration request or is associated with cryptographic material usable by the target core network node to decrypt and/or verify an integrity of the protected security context, wherein receiving the signaling including the protected security context comprises receiving a protected container that includes the security context and the one or more parameters, and wherein performing one or more security actions on the protected security context comprises performing the one or more security actions on the protected container.

48. The method of claim 47, wherein the one or more parameters include at least one of any one or more of:
an uplink or downlink non-access stratum count value;
a horizontal key derivation indicator that indicates whether or not the another core network node has performed horizontal key derivation to derive a cryptographic key included in the security context; and
a timestamp usable to verify a validity of cryptographic material usable by the core network node to decrypt and/or verify an integrity of the protected security context.

49. A method performed by a network node in a wireless communication network, the method comprising:
receiving, from a core network node in the wireless communication network, a request for cryptographic material, wherein the request includes three or more parameters, wherein the three or more parameters comprise at least:
an identifier or address of the core network node, or an identifier or address of a core network node set to which the core network node belongs;
an identifier or address of another core network node with which the cryptographic material is to be shared, or an identifier or address of another core network node set to which said another core network node belongs; and
a registration request requesting registration of the wireless device with the wireless communication network;
generating the requested cryptographic material based on the three or more parameters included in the request; and
transmitting, to the core network node, the generated cryptographic material in response to the request.

50. The method of claim 49, wherein the three or more parameters further include an identifier that identifies a wireless device or identifies a subscription associated with the wireless device.

51. The method of claim 49, further comprising transmitting, to the core network node, a cryptographic material reference associated with the cryptographic material in response to the request, wherein the cryptographic material reference comprises an identifier of the cryptographic material or comprises a token specific to the cryptographic material.

52. A core network node configured for use in a wireless communication network, the core network node comprising:
communication circuitry; and
processing circuitry configured to:
receive a registration request that requests registration of a wireless device with the wireless communication network;
protect a security context shared between the wireless device and the core network node, wherein protecting the security context comprises encrypting the security context; and
transmit, to a radio network node in the wireless communication network, signaling that includes the registration request and the protected security context, wherein the signaling indicates the registration request and the protected security context are to be re-routed to a target core network node in the wireless communication network.
